(19) United States
(12) Patent Application Publication
(10) Pub. No.: US 2006/0182575 A1
(43) Pub. Date: Aug. 17, 2006

(54) Pull and lift system for transporting roofing materials

(76) Inventor: Richard W. Poque, Pevely, MO (US)

Correspondence Address: Henry W. Cummings, 3313 W. Adams St., St. Charles, MO, 63301, US

(21) Appl. No.: 11/034,245

(22) Filed: Jan. 13, 2005

(51) Int. Cl. B60P 1/00

(52) U.S. Cl. 414/509

(57) ABSTRACT

The pull and lift system of the present invention transfers roofing materials from the pullbar extended position 14, FIG. 1, located at the headboard 1a of a truck bed to the lift table 6 shown in FIG. 1, by hydraulic rams 8, FIG. 1. The pull and lift system raises roofing material via the lift table 6 so as to eliminate excessive bending by the person picking up said material, by hydraulic rams 9, shown in FIG. 4.

### FIELD, OBJECTS AND SUMMARY OF THE INVENTION

One object of the the pull and lift system of the present invention is to transfer roofing and other construction materials longitudinally mechanically on a truck bed from a the pullbar extended position on a truck bed 14, FIG. 1, located at the headboard 1a of the truck bed to the lift table 6 shown in FIG. 1. This is done by hydraulic rams 8, shown in FIG. 1.

Another object of the present invention is to lift roofing and other constrution materials vertically from a truck bed with a lift table 6 so as to eliminate excessive bending by the person picking up said material. This is done by hydraulic rams 9, shown in FIG. 4.

### THE DRAWINGS

FIG. 1 is a plan view of the pull and lift system of the present invention with the pull bar in extended position.

FIG. 2 is a plan view of the pull and lift system of the present invention with the pull bar in retracted position.

FIG. 3 is a side view of the pull and lift system of the present invention with the lift table 13 at the lowered position 15 at the rear of the truck bed.

FIG. 4 is a side view of the pull and lift system of the present invention with the lift table 13 at the elevated position 17 at the rear of the truck bed.

FIG. 5 is an end elevation view of the pull and lift system of the present invention with the lift table 13 at the lowered position 15 at the rear of the truck bed.

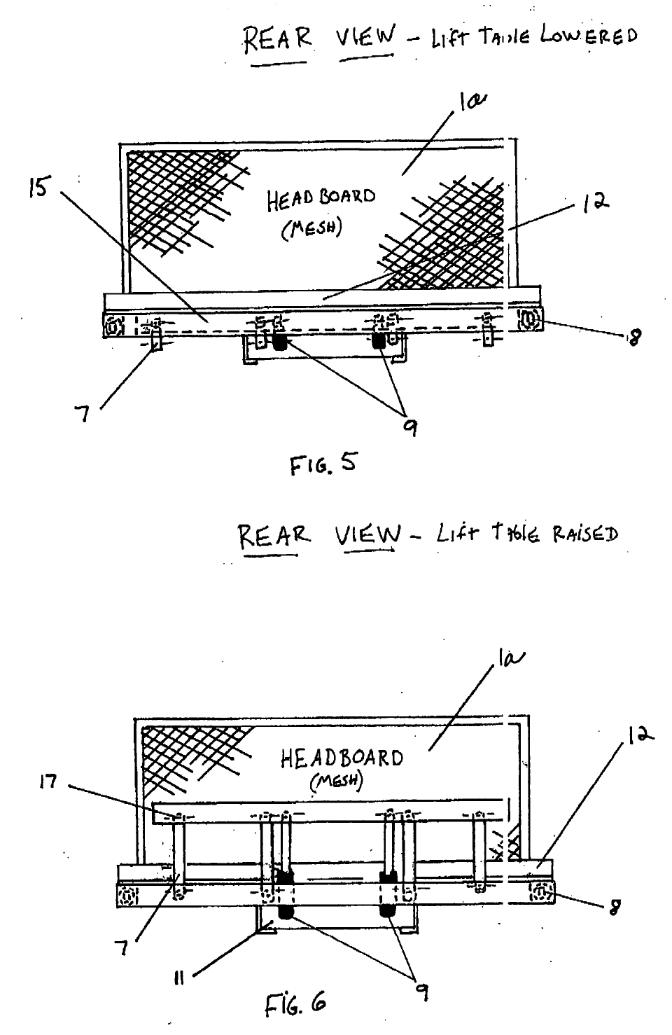

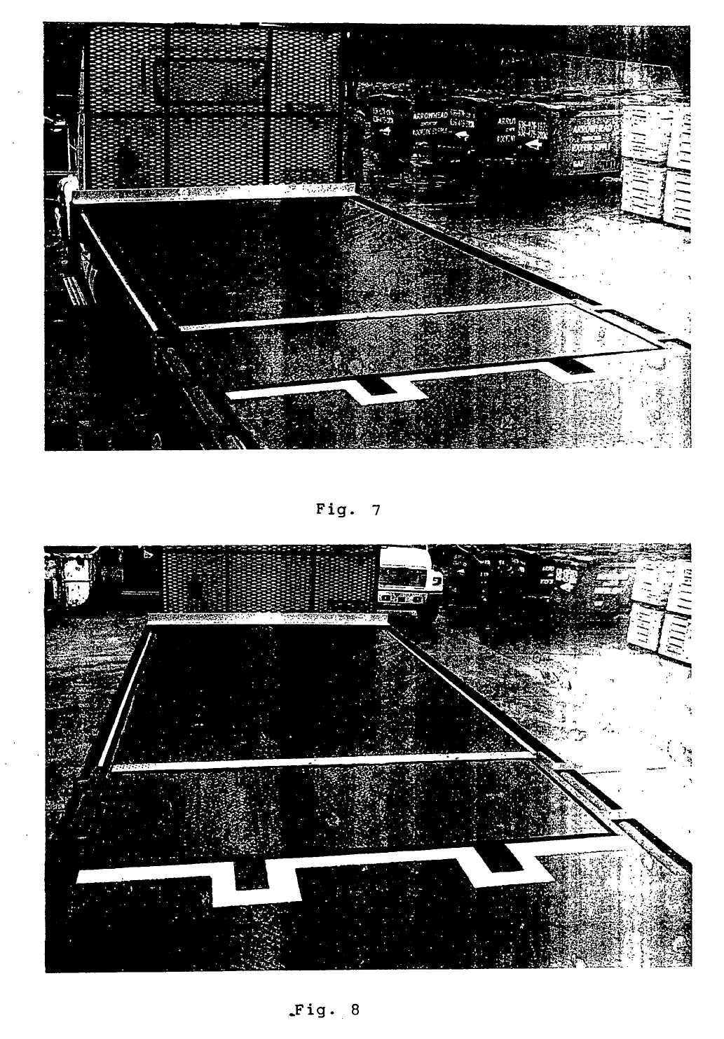

FIG. 4 is an end elevation view a of the pull and lift system of the present invention with lift table 13 at the elevated position 17 at the rear of the bed.

FIGS. 7 and 8 are color photographs of color safety stripes 5.

### DESCRIPTION OF PREFERRED EMBODIMENTS

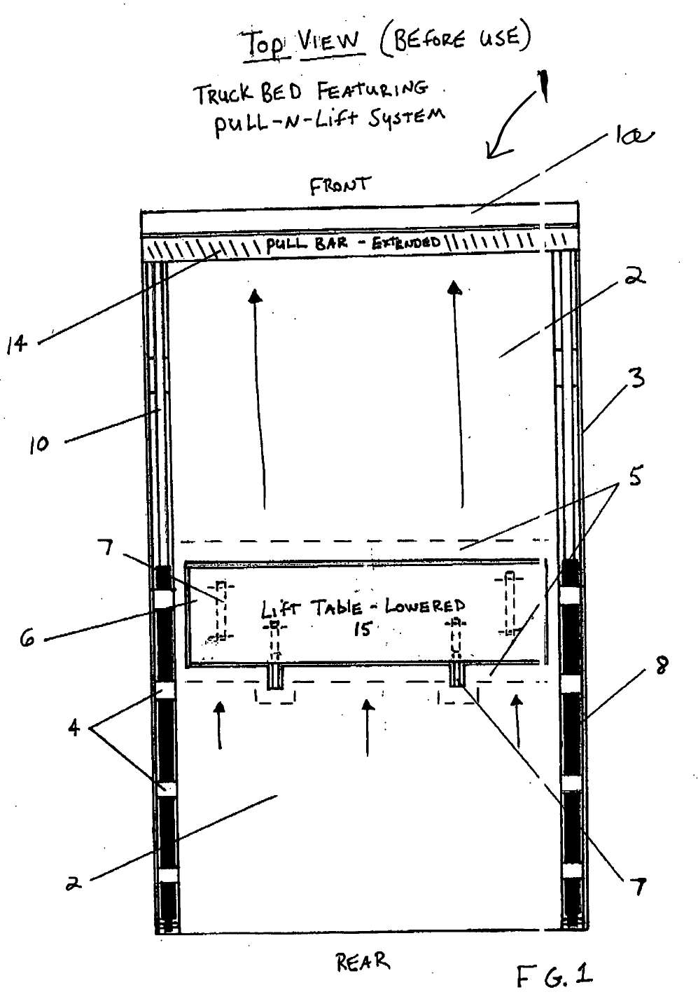

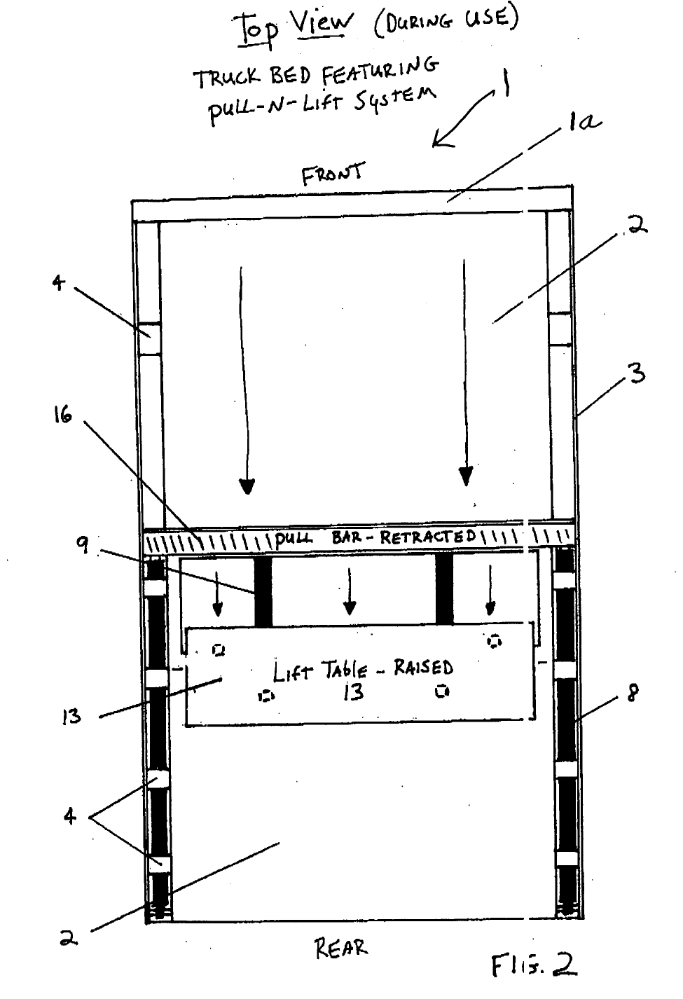

The pull and lift system of the present invention is illustrated in the drawings at 1. The pull and lift system includes a pull bar shown in extended positiion in FIG. 1 at 14, and in retracted position at 16 in FIG. 2.

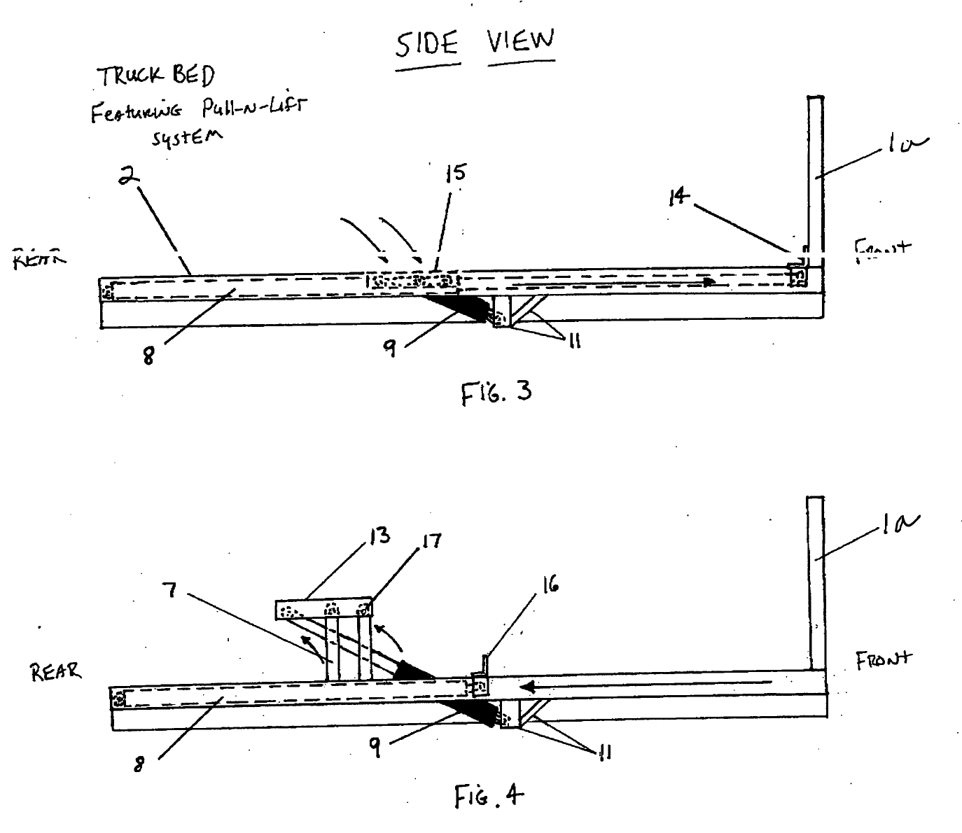

The pull and lift system also includes a lift table 6 shown in lowered position at 15 in FIG. 3, and having an raised position shown in FIG. 4.

The pull and lift system has the ability to transfer roofing materials from the pullbar extended position 14, FIG. 1, located at the headboard 1a of a truck bed to the lift table 6 shown in FIG. 1. The transfer is accomplished by dual hydraulic rams 8 and the transfer ends at the pull bar retracted position 116 shown in FIG. 2.

The pull and lift system also has the ability to raise roofing material via the lift table 6 so as to eliminate excessive bending by the persor picking up said material. The power to raise the lift table 13, FIG. 4 is provided by hydraulic rams 9, shown in FIG. 4.

In one embodiment, the pull bar extended 14, FIG. 1, drags roofing material from the headboard 1a at the front of the truck bed to the lift table 13 at the lowered position 15 at the rear of the truck bed. This is done with drasticaJly increased range of motion from the prior art, and at double the load capacity of the load capacity of the prior art.

In another embodiment, the lift table lowered 15 raises roofing material to a height exceeding that of the prior art to the lift table raised position 17 shown in FIG. 4.

In another embodiment, moving parts of the pull and lift system are signified by safety stripes 5, FIGS. 1, 7 and 8 to convey to an operator to “keep clear” of moving parts.

In another embodiment, the pull and lift system 1 is powered by an electric motor.

In another embodiment, the pull and lift system 1 is powered by or by a power take-off system, where the pull and lift system is powered by a power steering pump located in the engine assembly of the vehicle.

What is claimed is:

1. A system for transfering construction materials from a first position to a second position comprising:
a pullbar extending transversely on a truck bed having a first extended position at a first position adjacent a headboard of a truck bed to a second position on a truck bed adjacent a a lift table located on said truck bed, and longitudinally spaced on said truck bed from said headboard;
and means for transferring said pullbar from said first position to said second position.

2. A pull system for transfering construction materials from a first position to a second position according to claim 1 wherein said transfer is accomplished by at least one hudraulic ram.

3. A pull system for transfering construction materials from a first position to a second position according to claim 2 wherein said transfer is accomplished by dual hydraulic rams.

4. A system for transfering construction materials from a first position to a second elevated position comprising:
a lift table extending transversely across said truck bed;
and means to raise said lift table from a first positiion located adjacent a truck bed, and and a second elevasted position located above said said truck bed.

5. A system for transfering construction materials from a first position to a second position according to claim 4 wherein said lift table transfer is accomplished by at least one hydraulic ram.

6. A system for transfering construction materials from a first position to a second position according to claim 5 wherein said transfer is accomplished by dual hydraulic rams.

7. A system for transfering construction materials from a first position to a second position comprising:
moving parts of the system are signified by safety stripes marked on the truck bed to convey to operators to “keep clear” of moving parts.

8. A system for transfering construction materials from a first position to a second position comprising:
a pullbar extending transversely on a truck bed having a first extended position at a first position adjacent a headboard of a truck bed to a second position on a truck bed adjacent a a lift table located on said truck bed, and longitudinally spaced on said truck bed from said headboard;
and means for transferring said pullbar from said first position to said second position; and means for transfering construction materials from said second position to a third position which third position is elevated with respect to said second position.

9. A system for transfering construction materials according to claim 8 wherein said transfer is accomplished by at least one hydraulic ram.

10. A system for transfering construction materials according to claim 9 wherein said vertical transfer is accomplished by at least two hydraulic rams.

11. A system for transfering construction materials according to claim 10 wherein both said horizontal transfer and said vertical transfer are each respectively accomplished by at least two hydraulic rams.

12. A system for transfering construction materials according to claim 7 wherein one of said safety strips is located adjacent a first extended position of said pull bar at a first position adjacent a headboard of a truck bed.

13. A system for transfering construction materials according to claim 12 wherein one of said safety strips is located adjacent a second retracted extended position of said pull bar.

14. A system for transfering construction materials according to claim 13 wherein one of said safety strips is located adjacent lift table slots located on said truck bed.

15. A system for transfering construction materials according to claim 13 wherein one of said safety strips is located adjacent a second retracted extended position of said pull bar.

16. A system for transfering construction materials according to claim 15 wherein one of said safety strips is located adjacent lift table slots located on said truck bed.
